(19) United States
(12) Patent Application Publication
(10) Pub. No.: US 2026/0368867 A1
(43) Pub. Date: Nov. 19, 2026

(54) METHOD FOR GENERATING DE-WARPED FIELD OF VIEW AND ELECTRONIC DEVICE

(71) Applicant: SAMSUNG ELECTRONICS CO., LTD., Suwon-si (KR)

(72) Inventor: Heung Rae CHO, Suwon-si (KR)

(73) Assignee: SAMSUNG ELECTRONICS CO., LTD., Suwon-si (KR)

(21) Appl. No.: 19/664,297

(22) Filed: Apr. 30, 2026

(30) Foreign Application Priority Data
May 13, 2025 (KR) 10-2025-0061806

(51) Int. Cl. G06T 5/80; G06F 16/23; G06T 5/60

(52) U.S. Cl. CPC G06T 5/80; G06F 16/23; G06T 5/60; G06T 2207/20084

(57) ABSTRACT

A method for image de-warping may include: receiving, from a camera device, a first original image having a first field of view (FOV), obtaining a plurality of first source coordinates constituting the first original image, inputting the plurality of first source coordinates and environmental information to a learning model, generating, by using the learning model based on the plurality of first source coordinates and the environmental information, a plurality of first destination coordinates constituting a first region of interest (ROI) having a second FOV different from the first FOV, generating a lookup table including the plurality of first source coordinates and the plurality of first destination coordinates, and performing de-warping for a plurality of original images received from the camera device based on the lookup table.

### CROSS REFERENCE TO RELATED APPLICATION

This application is based on and claims priority from Korean Patent Application No. 10-2025-0061806 filed on May 13, 2025, in the Korean Intellectual Property Office and all the benefits accruing therefrom under 35 U.S.C. 119, the contents of which in its entirely are herein incorporated by reference.

### BACKGROUND

### Field

The present invention relates to a method for image de-warping and an electronic device.

### 2. Description of Related Art

As the demand for convenience and safety of vehicle operation increases, various technologies for assisting the vehicle operation have been developed. For example, an advanced driver assistance system (ADAS) or an autonomous driving system (AD) may cause a vehicle to recognize or determine some situations during driving using a camera, a sensing sensor, an image processing device, a communication device, and the like, and control the operation of the vehicle or inform the driver of the situations. For example, the camera may capture the driving situation of the vehicle and input it into the advanced driver assistance system or the autonomous driving system algorithm or provide it to the driver. At this time, in order to accurately grasp the driving situation of the vehicle, it is necessary to obtain images captured at various fields of view (FOV), and it is also necessary to obtain images in which distortion caused by factors such as the curvature of the lens of the camera module is corrected.

### SUMMARY

One or more embodiments of the present disclosure may provide a method for image de-warping.

One or more embodiments of the present disclosure may provide an electronic device that executes a method for image de-warping.

One or more embodiments of the present disclosure may provide a non-transitory computer-readable recording medium that stores commands that cause a processor to execute the method for image de-warping.

However, the present disclosure is not restricted to the embodiments set forth herein. The above and other aspects of the present disclosure will become more apparent to one of ordinary skill in the art to which the present disclosure pertains by referencing the detailed description of the present disclosure given below.

One or more embodiments of the present disclosure may provide a method for image de-warping, the method including: receiving, from a camera device, a first original image having a first field of view (FOV), obtaining a plurality of first source coordinates constituting the first original image, inputting the plurality of first source coordinates and environmental information to a learning model, generating, by using the learning model based on the plurality of first source coordinates and the environmental information, a plurality of first destination coordinates constituting a first region of interest (ROI) having a second FOV different from the first FOV, generating a lookup table including the plurality of first source coordinates and the plurality of first destination coordinates, and performing de-warping for a plurality of original images received from the camera device based on the lookup table.

One or more embodiments of the present disclosure may provide an electronic device including: a camera device, at least one processor, and memory storing instructions, wherein the instructions, when executed by the at least one processor, cause the at least one processor to: receive, from the camera device, a first original image having a first field of view (FOV), obtain a plurality of first source coordinates constituting the first original image, input the plurality of first source coordinates and environmental information to a learning model, generate, by using the learning model based on the plurality of first source coordinates and the environmental information, a plurality of first destination coordinates constituting a first region of interest (ROI) having a second FOV different from the first FOV, generate a lookup table including the plurality of first source coordinates and the plurality of first destination coordinates, and perform de-warping for a plurality of original images received from the camera device based on the lookup table.

One or more embodiments of the present disclosure may provide a non-transitory computer-readable medium storing instructions which, when executed by at least one processor, cause the at least one processor to execute a method for image de-warping, the method including: receiving, from a camera device, a first original image having a first field of view (FOV), obtaining a plurality of first source coordinates constituting the first original image, inputting the plurality of first source coordinates and environmental information to a learning model, generating, by using the learning model based on the plurality of first source coordinates and the environmental information, a plurality of first destination coordinates constituting a first region of interest (ROI) having a second FOV different from the first FOV, generating a lookup table including the plurality of first source coordinates and the plurality of first destination coordinates, and performing de-warping for a plurality of original images received from the camera device based on the lookup table.

Particular matters of one or more embodiments are included in the detailed description and drawings.

### BRIEF DESCRIPTION OF DRAWINGS

FIG. 1 is a diagram for explaining a method for correcting image distortion.

FIG. 2 is a block diagram for explaining an electronic device that generates a plurality of fields of view.

FIG. 3 is a block diagram for explaining an electronic device according to one or more embodiments.

FIG. 4 is a block diagram for explaining an electronic device according to one or more embodiments.

FIG. 5 is a flowchart for explaining a method for image de-warping according to one or more embodiments.

FIG. 6 is a diagram for explaining a method for image de-warping according to one or more embodiments.

FIG. 7 is a flowchart for explaining a method for image de-warping according to one or more embodiments.

FIG. 8 is a diagram for explaining a method for setting a region of interest on the basis of the environmental information according to one or more embodiments.

FIG. 9 is a flowchart for explaining a method for image de-warping according to one or more embodiments.

FIG. 10 is a flowchart for explaining a method for generating the de-warped field of view on the region of interest according to one or more embodiments.

FIG. 11 is a flowchart for explaining a method for generating a de-warped field of view on the region of interest according to one or more embodiments.

FIG. 12 is a diagram for explaining a method for generating a de-warped field of view on the region of interest according to one or more embodiments.

FIG. 13 is a diagram for explaining a image de-warping according to one or more embodiments.

FIG. 14 is a block diagram for explaining a system according to one or more embodiments.

### DETAILED DESCRIPTION

Hereinafter, embodiments according to the technical idea of the present disclosure will be described with reference to the attached drawings.

All of the embodiments of the disclosure described herein are example embodiments, and thus, the disclosure is not limited thereto, and may be realized in various other forms. Each of the embodiments provided in the following description is not excluded from being associated with one or more features of another example or another embodiment also provided herein or not provided herein but consistent with the disclosure.

It will be understood that when an element, component, layer, pattern, structure, region, or so on (hereinafter collectively “element”) of a semiconductor device is referred to as being “over,” “above,” “on,” “below,” “under,” “beneath,” “connected to” or “coupled to” another element of the semiconductor device, it can be directly over, above, on, below, under, beneath, connected or coupled to the other element or an intervening element(s) may be present. In contrast, when an element of a semiconductor device is referred to as being “directly over,” “directly above,” “directly on,” “directly below,” “directly under,” “directly beneath,” “directly connected to” or “directly coupled to” another element of the semiconductor device, there are no intervening elements present. Like numerals refer to like elements throughout this disclosure.

As used herein, the term “and/or” includes any and all combinations of one or more of the associated listed items. As used herein, expressions such as “at least one of,” when preceding a list of elements, modify the entire list of elements and do not modify the individual elements of the list. For example, the expression, “at least one of a, b and c,” and “at least one of a, b, or c” should be understood as including only a, only b, only c, both a and b, both a and c, both b and c, or all of a, b and c.

It will be also understood that, even if a certain step or operation of manufacturing an apparatus or structure is described later than another step or operation, the step or operation may be performed later than the other step or operation unless the other step or operation is described as being performed after the step or operation.

In this disclosure, the steps constituting the method may be performed in any suitable order unless there is an obvious mention that they should be performed in the order described. For example, the steps constituting the method may be performed in the reverse order to that described, and some of the steps constituting the method may be performed simultaneously.

Various embodiments of the present document and terms used therein are not intended to limit the technical features described in this document to specific embodiments, and should be understood to include various modifications, equivalents, or substitutes of the corresponding embodiments.

In connection with the description of the drawings, similar reference numerals may be used for similar or related components.

The singular form of a noun corresponding to an item may include one or a plurality of the items unless clearly indicated otherwise in a related context.

In addition, the terms “portion”, “part”, “unit”, “module” or “member” may be implemented in hardware or software. Depending on the embodiments, a plurality of “portions”, “parts”, “units”, “modules” or “members” may be implemented as a single element, or a single “portion”, “part”, “unit”, “module” or “member” may include a plurality of elements.

It will be understood that, although the terms “first”, “second”, “third”, “primary”, “secondary”, “tertiary”, etc., may be used herein to describe various elements, but elements are not limited by these terms. These terms are only used to distinguish one element from another element. For example, without departing from the scope of the disclosure, a first element may be termed as a second element, and a second element may be termed as a first element. The term of “and/or” includes a plurality of combinations of relevant items or any one item among a plurality of relevant items.

When an element (e.g., a first element) is referred to as being “(functionally or communicatively) coupled” or “connected” to another element (e.g., a second element), the first element may be connected to the second element, directly (e.g., wired), wirelessly, or through a third element.

In this disclosure, the terms “including”, “comprising”, “having”, and the like are used to specify features, numbers, steps, operations, elements, components, or combinations thereof, but do not preclude the presence or addition of one or more of the features, numbers, steps, operations, elements, components, or combinations thereof.

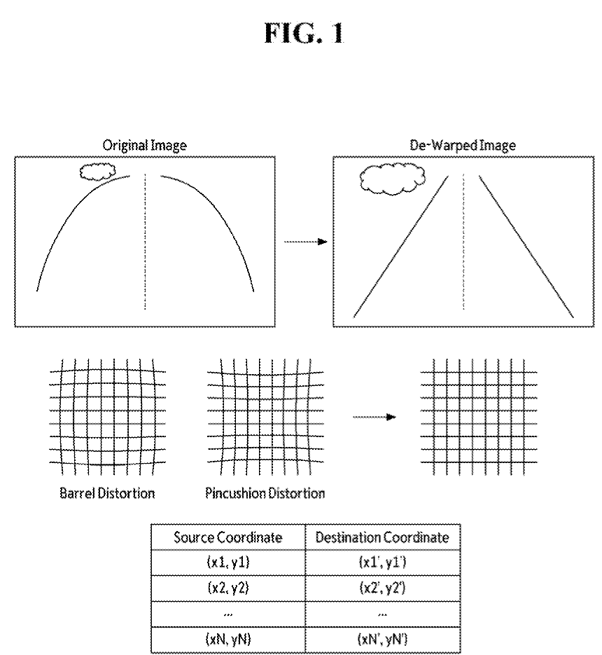

FIG. 1 is a diagram for explaining a method for correcting image distortion. Referring to FIG. 1, an advanced driver assistance system (ADAS) algorithm or an autonomous driving system (AD) algorithm may receive data on the current driving situation, process the data, and control the vehicle or process and provide information on the current driving situation to the driver. The vehicle may acquire data on the current driving situation using a camera, a detection sensor, or the like. For example, the vehicle may acquire an image on the current driving situation through a camera. At this time, distortion may exist in an original image captured by the camera. Since the warped image fails to accurately reflect the current driving situation, a distortion correction (de-warping) needs to be performed on the original image. The image in which the de-warping is performed (de-warped image) may accurately reflect the current driving situation.

Distortion of the original image may occur for various reasons. For example, in the case of a spherical lens, light may be refracted differently at the center of the lens and at its periphery, which may change the magnification at the center and periphery of the lens. This may result in barrel distortion or pincushion distortion. The barrel distortion refers to a distortion in which straight lines of the image bend bulgingly outward, and may occur frequently mainly in wide-angle lenses. The pincushion distortion refers to a distortion in which straight lines of the image bend inward and warp, and may occur frequently mainly in telephoto lenses.

When performing the de-warping, a look-up table (LUK) is generally used. The look-up table may include a plurality of source coordinates and a plurality of destination coordinates corresponding to each source coordinate. The plurality of source coordinates may be a plurality of pixel coordinates that constitute the original image. The plurality of destination coordinates may be a plurality of pixel coordinates that constitute the de-warped image.

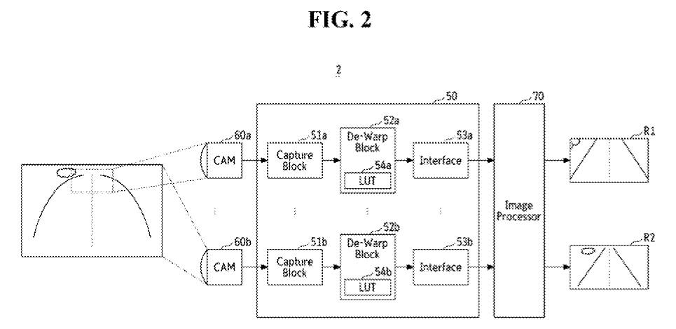

FIG. 2 is a block diagram for explaining an electronic device that generates a plurality of fields of view. Referring to FIG. 2, an electronic device 2 may include an integrated circuit 50, a plurality of camera modules 60a and 60b (i.e., camera devices and/or camera apparatuses), and an image processor 70.

The plurality of camera modules 60a and 60b may include a first camera module 60a and a second camera module 60b that have different focal lengths from each other. The first camera module 60a may be a camera module having a longer focal length than the second camera module 60b. The first camera module 60a may acquire an image with a narrow field of view to accurately capture a distant object. The second camera module 60b may be a camera module having a shorter focal length than the first camera module 60a. The second camera module 60b may acquire an image with a wide field of view to accurately capture a close object. The field of view (FOV) indicate how wide an area the camera can capture. When the FOV is wide, the image shows a broad area, whereas when the FOV is narrow, the image shows a narrow area. In the present disclosure, the FOV may refer to the field of view indicating how wide an area the camera can capture, or it may refer to an image itself that has a particular field of view. The plurality of camera modules 60a and 60b may capture an object to acquire an original image OI in which the distortion is not corrected. The number of camera modules is not limited to two as shown in FIG. 2, and may include camera modules having three or more different focal lengths according to one or more embodiments of the present disclosure. As an example, the plurality of camera modules may be a trifocal camera including camera modules having three different focal lengths from each other.

The integrated circuit 50 may include image capture blocks 51a and 51b, de-warping blocks 52a and 52b, and interfaces 53a and 53b. The image capture blocks 51a and 51b may include hardware including logic circuits, software, or a combination of hardware and software. When the image capture blocks 51a and 51b include hardware or a combination of hardware and software, the image capture blocks 51a and 51b may be implemented through a processing circuit. The processing circuit may include, but is not limited to, a central processing unit (CPU), an arithmetic logic unit (ALU), a digital signal processor, a microcomputer, a field programmable gate array (FPGA), a system-on-chip (SoC), a programmable logic, a programmable unit, a microprocessor, an application-specific integrated circuit (ASIC), and the like. The image capture blocks 51a and 51b may provide images acquired from plurality of camera modules 60a and 60b to the de-warping blocks 52a and 52b. The image capture blocks 51a and 51b may also perform the image processing on the images acquired from the plurality of camera modules 60a and 60b. For example, the image capture blocks 51a and 51b may also perform at least one image processing among demosaicing, denoising, white balancing, color correction, gamma correction, lens shading correction, chromatic aberration, and sharpening. The image capture blocks 51a and 51b may further include an interface that connects the plurality of camera modules 60a and 60b to the integrated circuit 50.

The de-warping blocks 52a and 52b may include hardware including logic circuits, software, or a combination of hardware and software. When the de-warping blocks 52a and 52b include hardware or a combination of hardware and software, the de-warping blocks 52a and 52b may be implemented through a processing circuit. The processing circuit may include, but is not limited to, a central processing unit (CPU), an arithmetic logic unit (ALU), a digital signal processor, a microcomputer, a field programmable gate array (FPGA), a system-on-chip (SoC), a programmable logic unit, a microprocessor, an application-specific integrated circuit (ASIC), and the like. The de-warping blocks 52a and 52b may perform de-warping on the images acquired by the corresponding camera modules. The de-warping blocks 52a and 52b may include look-up tables 54a and 54b on the images acquired by the corresponding camera modules. Each of the look-up tables 54a and 54b may include a plurality of source coordinates and a plurality of destination coordinates corresponding to each source coordinate. Each of the look-up tables 54a and 54b may include fixed source coordinates and destination coordinates that may be applied only to the corresponding camera module.

The interfaces 53a and 53b may connect the integrated circuit 50 and the image processor 70 on the basis of various communication protocols. The interfaces 53a and 53b may include, but are not limited to, a peripheral component interconnect bus express (PCIe), a universal serial bus (USB), a mobile industry processor interface (MIPI), a Marconi, universal flash storage (UFS), a memory interface (MIF), an inter-integrated circuit (I2C), and/or an improved inter-integrated circuit (I3C).

The image processor 70 may process the image data received from the integrated circuit 50 and provide the processed image data to an advanced driver assistance system (ADAS) algorithm or an autonomous driving system (AD) algorithm, or may directly provide the processed image data to a user. The image processor 70 may include, for example, a central processing unit (CPU), a graphics processing unit (GPU), a programmable logic device, a specialized processor system, a microcontroller, and/or a microprocessor. The image processor 70 may also include an accelerator, which is a dedicated circuit for high-speed data computations such as AI (artificial intelligence) data computations. The image processor 70 may include, for example, a graphics processing unit (GPU), a neural processing unit (NPU), a data processing unit (DPU), and the like, and may be implemented as a separate chip that is physically independent from other components of the integrated circuit 50. The image processor 70 may process the image data received from the integrated circuit 50 to generate a field of view (FOV) for each of the corresponding camera modules. In conclusion, an original image may be acquired by the first camera module 60a, and the de-warping may be performed via the de-warping block 52a to acquire a de-warped image for the first field of view R1 subjected to the image processing. Also, an original image is acquired by the second camera module 60b, and the de-warping may be performed via the de-warping block 52b to acquire a de-warped image for the second field of view R2 subjected to the image processing.

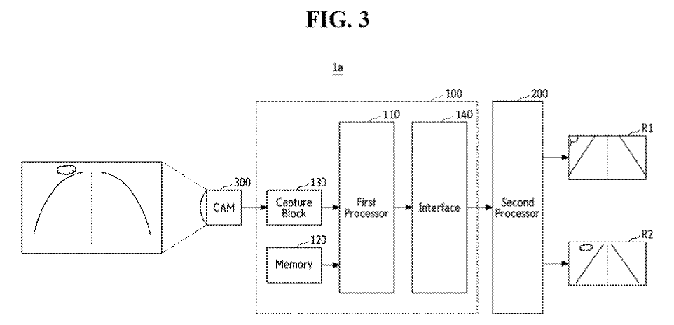

FIG. 3 is a block diagram for explaining an electronic device according to one or more embodiments. Referring to FIG. 3, the electronic device 1a may include an integrated circuit 100, a second processor 200, and a camera module 300. Unlike the camera module of FIG. 2, the camera module 300 may be configured as a single camera module. The second processor 200 may include at least one processor. That is, the second processor 200 may include one or more processors. The camera module 300 may provide the captured original image to the integrated circuit 100.

The integrated circuit 100 may include a first processor 110, a memory 120, an image capture block 130, and an interface 140. The first processor 100 may include at least one processor. That is, the first processor 100 may include one or more processors. The image capture block 130 may include hardware including logic circuits, software, or a combination of hardware and software. When the image capture block 130 includes hardware or a combination of hardware and software, the image capture block 130 may be implemented through a processing circuit. The processing circuit may include, but is not limited to, a central processing unit (CPU), an arithmetic logic unit (ALU), a digital signal processor, a microcomputer, a field programmable gate array (FPGA), a system-on-chip (SoC), a programmable logic unit, a microprocessor, an application-specific integrated circuit (ASIC), and the like. The image capture block 130 may provide an image acquired from the camera module 300 to the first processor 110. The image capture block 130 may also perform the image processing on the image acquired from the camera module 300. For example, the image capture block 130 may perform demosaicing, denoising, white balancing, color correction, gamma correction, lens shading correction, chromatic aberration and sharpening. The image capture block 130 may further include an interface that connects the camera module 300 and the integrated circuit 100.

The first processor 110 may include, for example, a central processing unit (CPU), a graphics processing unit (GPU), a programmable logic device, a specialized processor system, a microcontroller, and/or a microprocessor. The first processor 110 may also include an accelerator, which is a dedicated circuit for high-speed data computations such as AI (artificial intelligence) data computations. The first processor 110 may further include a dedicated processor for artificial intelligence, such as a graphics processing unit (GPU), a neural processing unit (NPU), and a data processing unit (DPU). The dedicated processor for artificial intelligence may be designed, for example, as a hardware structure specialized for processing a particular artificial intelligence model.

The memory 120 may store data, commands, and the like. The memory 120 may include a volatile memory, such as a static random access memory (SRAM) and/or a dynamic random access memory (DRAM), but may include a non-volatile memory, such as a flash memory, a phase-change RAM (PRAM), a resistive RAM (RRAM) and a magnetic RAM (MRAM). The memory 120 may be integrated on the first processor 110 and one chip or an integrated circuit, but is not limited thereto.

Since the memory 120 and the first processor 110 may be operatively coupled and may communicate with each other through an I/O port, a network connection, and the like, the first processor 110 may read data, commands, and the like stored in the memory 120. According to one or more embodiments, the commands stored in the memory 120, when executed by the first processor 110, may cause the first processor 110 to execute at least a part of a method for image de-warping. The method for image de-warping will be described below.

The memory 120 may store an artificial intelligence model. The artificial intelligence model may be made up of a plurality of neural network layers. Each of the plurality of neural network layers may have a plurality of weight values, and perform neural network computations through the computation results of the previous layer and computations between the plurality of weight values. The plurality of weight values of the plurality of neural network layers may be optimized by the learning results of the artificial intelligence model. For example, the plurality of weight values may be updated so that the loss value or the cost value acquired in the artificial intelligence model during the learning process is reduced or minimized. The artificial intelligence model may include, but is not limited to, for example, a convolutional neural network (CNN), a deep neural network (DNN), a recurrent neural network (RNN), a restricted Boltzmann machine (RBM), a deep belief network (DBN), a bidirectional recurrent deep neural network (BRDNN), a generative adversarial (GAN), deep Q-networks, the like.

The artificial intelligence model may be a learning model. The learning model means a predetermined operating rule or an artificial intelligence model that is set to perform a desired characteristic (or purpose) by the artificial intelligence model being learned using the plurality of learning data by a learning algorithm. Such learning may be performed on the electronic device 1a itself or may be performed through a separate server or system. Examples of the learning algorithms include, but are not limited to, supervised learning, unsupervised learning, semi-supervised learning or reinforcement learning. The artificial intelligence models will be described in more detail below.

The interface 140 may connect the integrated circuit 100 and the second processor 200 on the basis of various communication protocols. The interface 140 may be, for example, but is not limited to, a peripheral component interconnect bus express (PCIe), a universal serial bus (USB), a mobile industry processor interface (MIPI), Marconi, a universal flash storage (UFS), a memory interface (MIF), an inter-integrated circuit (I2C), and/or an improved inter-integrated circuit (I3C).

The second processor 200 may process the image data received from the integrated circuit 100 and provide the processed image data to an advanced driver assistance system (ADAS) algorithm or an autonomous driving system (AD) algorithm, or may directly provide the image data to a user. The second processor 200 may include, for example, a central processing unit (CPU), a graphics processing unit (GPU), a programmable logic device, a specialized processor system, a microcontroller, and/or a microprocessor. The second processor 200 may also include an accelerator, which is a dedicated circuit for high-speed data computations such as artificial intelligence (AI) data computations. The second processor 200 may include, for example, a graphics processing unit (GPU), a neural processing unit (NPU), and a data processing unit (DPU), and may be implemented as a separate chip that is physically independent from other components of the integrated circuit 100. According to the embodiments of the present disclosure, the second processor 200 may be omitted. According to one or more embodiments, the second processor 200 (or the integrated circuit 100 when the second processor 200 is omitted) may output, for example, one or more de-warped fields of view R1 and R2.

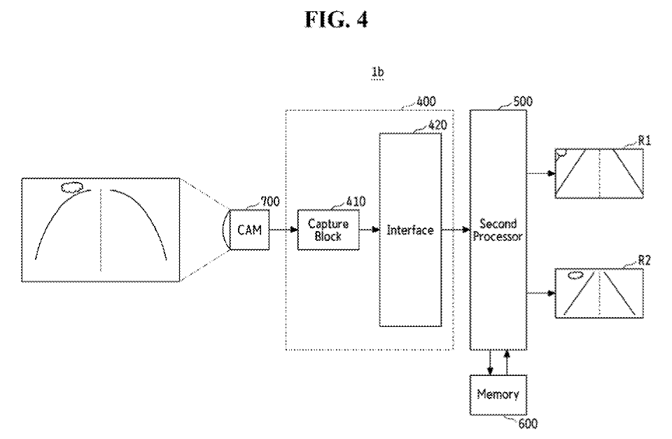

FIG. 4 is a block diagram for explaining an electronic device according to one or more embodiments. Referring to FIG. 4, an electronic device 1b may include an integrated circuit 400, a processor 500, a memory 600, and a camera module 700. Unlike FIG. 3, according to one or more embodiments, the memory 600 and the processor 500 may be implemented as separate chips or integrated circuits independent of the integrated circuit 400.

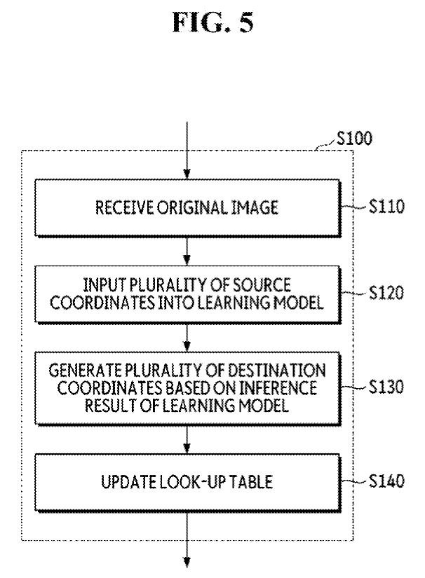

FIG. 5 is a flowchart for explaining a method for image de-warping according to one or more embodiments. Referring to FIG. 5, the method (S100) for image de-warping may include a step (S110) in which a processor receives an original image. Specifically, for example, a processor (e.g., 110 of FIG. 3 and/or 500 of FIG. 4) may receive an original image captured using a camera module (e.g., 300 of FIG. 3 and/or 700 of FIG. 4) having a first field of view.

According to one or more embodiments, the method (S100) for image de-warping may include a step (S120) in which the processor inputs a plurality of source coordinates into the learning model. Specifically, for example, the processor (e.g., 110 of FIG. 3 and/or 500 of FIG. 4) may input a plurality of source coordinates corresponding to the original image into the learning model (e.g., an artificial intelligence model stored in the memory 120 of FIG. 3).

According to one or more embodiments, the method (S100) for image de-warping may include a step (S130) in which the processor generates a plurality of destination coordinates on the basis of an inference result of the learning model. Specifically, for example, the processor (e.g., 110 of FIG. 3 and/or 500 of FIG. 4) may generate a plurality of destination coordinates in which the distortion is corrected on the basis of the inference result of the learning model (e.g., an artificial intelligence model stored in the memory 120 of FIG. 3).

According to one or more embodiments, the method (S100) for image de-warping may include a step (S140) in which the processor generates the look-up table. Specifically, for example, the processor (e.g., 110 of FIG. 3 and/or 500 of FIG. 4) may generate the look-up table on the basis of a plurality of source coordinates and a plurality of destination coordinates generated on the basis of the inference result. The processor may perform the de-warping for a plurality of original images received from the camera module on the basis of the generated look-up table. The processor may provide the de-warped image to an advanced driver assistance system algorithm or an autonomous driving system algorithm, or may directly provide the de-warped image to a user, and may further perform additional processing steps (e.g., field of view generation for a region of interest).

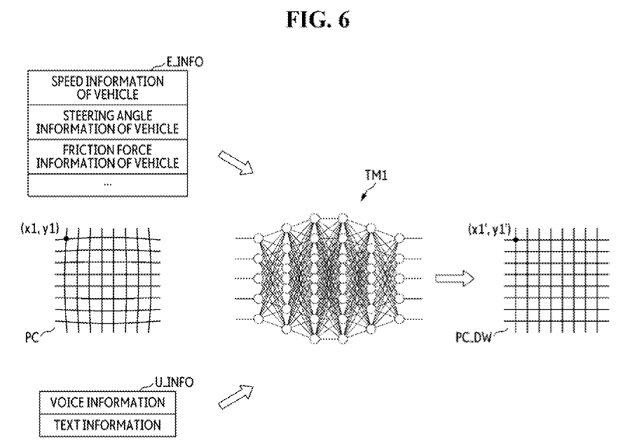

FIG. 6 is a diagram for explaining a method for image de-warping according to one or more embodiments. Referring to FIG. 6, a first learning model TM1 may be used to generate the look-up table. The first learning model TM1 may be learned on the basis of (i.e., based on) a plurality of look-up tables. The plurality of look-up tables may be made up of source coordinates for each of a plurality of images and destination coordinates corresponding to each source coordinate. For example, the first learning model TM1 may be learned so that, when a plurality of source coordinates PC corresponding to a particular image are input, a plurality of destination coordinates PC_DW in which the distortion of the particular image is corrected may be inferred.

The degree of de-warping may vary depending on environmental information and/or user input information. As an example, when it rains, rainwater may cause lens distortion. That is, the degree of de-warping may vary when it rains and when it does not rain. Therefore, when the first learning model TM1 is further learned on the basis of a plurality of types of environmental information E_INFO and/or a plurality of types of user input information U_INFO, the distortion of the original image may be corrected more accurately. According to one or more embodiments, the first learning model TM1 may be learned further on the basis of the plurality of types of environmental information E_INFO and/or the plurality of types of user input information U_INFO. The plurality of types of environmental information E_INFO may include, for example, speed information of a vehicle, steering angle information of the vehicle, and/or friction force information of the vehicle with the ground and the like. The plurality of types of user input information U_INFO may include, for example, user voice information and/or text information, and the like. For example, the first learning model TM1 may be learned to infer a plurality of destination coordinates PC_DW in which distortion of the particular image is corrected, when a plurality of source coordinates PC and environmental information E_INFO corresponding to the particular image are input, or when a plurality of source coordinates PC and user input information U_INFO corresponding to the particular image are input, or when the plurality of source coordinates PC, environmental information E_INFO and user input information U_INFO corresponding to the particular image are input.

Referring again to FIG. 2, the electronic device 2 may include a plurality of camera modules 60a and 60b, and each of the camera modules 60a and 60b may acquire an image of a fixed field of view. The de-warping blocks 52a and 52b of the integrated circuit 50 may each include fixed look-up tables 54a and 54b, and may perform de-warping only on images received from the corresponding camera module. Also, each of the look-up tables 54a and 54b may require updating for various reasons, for example, when the position or direction of the camera module changes, the focus changes (e.g., when using optical zoom and/or auto-focus (AF) functions), or when the internal parameters of the camera module change, and a manual calibration work for writing a new look-up table into the memory needs to be performed for each vehicle and update the look-up table.

According to one or more embodiments, the processor may update the look-up table by the use of the learning model, and may perform de-warping dynamically. For example, the processor may update the look-up table in response to at least one of: a change in position of the camera module, a change in orientation of the camera module, a change in focus of the camera module, or a change in one or more parameters of the camera module. The process of generating the lookup table described above may be repeated to update the lookup table. For example, the processor may receive a new original image from the camera module in order to update the lookup table. The processor may generate new destination coordinates based on the source coordinates for the new original image. The processor may update the lookup table based on the source coordinates and the new destination coordinates for the new original image. That is, the processor may perform the de-warping dynamically by the use of the learning model, even under situations in which the position or direction of the camera module changes, the focus changes (e.g., when using optical zoom and/or auto-focus (AF) functions), the internal parameters of the camera module change, or the region of interest is photographed by the use of functions such as the optical zoom and the auto-focus (AF).

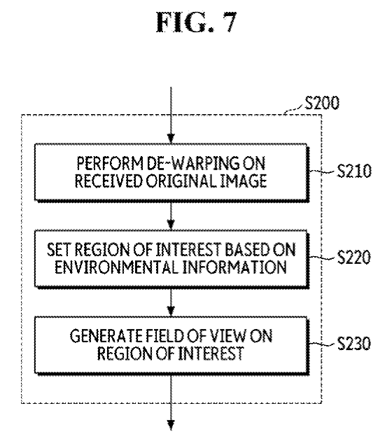

FIG. 7 is a flowchart for explaining a method for image de-warping according to one or more embodiments. Referring to FIG. 7, the method (S200) for image de-warping may include a step (S210) in which the processor performs de-warping on the received original image. Specifically, for example, the processor (e.g., 110 of FIG. 3 and/or 500 of FIG. 4) may receive an original image having a first field of view acquired using the camera module (e.g., 300 of FIG. 3 and/or 700 of FIG. 4) and perform de-warping on the received original image. The de-warping may be performed by the processor using a fixed look-up table, or may be performed by the processor using a look-up table generated on the basis of the inference result of a learning model (e.g., the first learning model TM1 of FIG. 6), and is not limited to any method.

According to one or more embodiments, the method (S200) for image de-warping may include a step (S220) in which the processor sets a region of interest on the basis of environmental information. Specifically, for example, the processor (e.g., 110 of FIG. 3 and/or 500 of FIG. 4) may set a region of interest (ROI) having a second field of view on the basis of the environmental information. Field of view of the ROI and field of view of the original image may be different from each other. The environmental information may be information including a current driving state or the like of a vehicle equipped with an electronic device according to one or more embodiments. The environmental information may include, for example, speed information of a vehicle, steering angle information of the vehicle, and friction force information of the vehicle (or tires mounted on the vehicle) with the ground (e.g., the type of tires mounted on the vehicle, the degree of wear of the tires, the duration of use of the tires, etc.). The region of interest may correspond to some in the input image required by an advanced driver assistance system algorithm, an autonomous driving system algorithm, or a user. The region of interest may vary, for example, depending on environmental information. As an example, the faster the vehicle speed is, the greater the braking distance increases in proportion to the vehicle speed. Thus, as the vehicle speed is fast, an observer (the advanced driver assistance system algorithm, the autonomous driving system algorithm, and/or the user) also needs to recognize distant obstacles. Thus, field of view of the region of interest of the input image may be narrower as the vehicle speed increases.

According to one or more embodiments, the method (S200) for image de-warping may include a step (S230) in which the processor generates a field of view on the region of interest. Specifically, for example, the processor (e.g., 110 of FIG. 3 and/or 500 if FIG. 4) may generate a field of view on the region of interest acquired at S220. The processor may provide the generated field of view to the advanced driver assistance system algorithm or the autonomous driving system algorithm, or directly to a user.

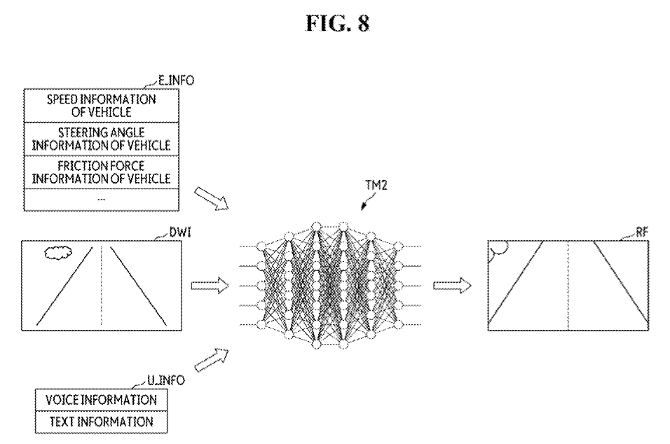

FIG. 8 is a diagram for explaining a method for setting a region of interest on the basis of the environmental information according to one or more embodiments. Referring to FIG. 8, a second learning model TM2 may be used to set a region of interest RF on the basis of the environmental information. The second learning model TM2 may be learned on the basis of at least one of a plurality of images, a plurality of types of environmental information E_INFO, and a plurality of types of region of interest information corresponding thereto. The plurality of types of environmental information E_INFO may include, for example, speed information of a vehicle, steering angle information of the vehicle, and/or friction force information of the vehicle with the ground. For example, the second learning model TM2 may be learned so that, when a particular image and particular environmental information are input, it may infer a region of interest corresponding to particular environmental information within a particular image.

The second learning model TM2 may be learned further on the basis of not only a plurality of types of environmental information E_INFO but also the user input information U_INFO. The user input information U_INFO may include, for example, user voice information and/or text information. The region of interest may also vary depending on, for example, the user input information. As an example, the user may provide voice commands to the vehicle to identify distant objects. Thus, the region of interest in the input image may be narrowed to identify distant objects. As another example, a weather forecast or the like may be provided to the vehicle in text information. When the weather forecast provides the vehicle with information that it will rain, the region of interest may be narrowed in consideration of an increase in braking distance of the vehicle. The second learning model TM2 receives particular environmental information and/or user input information, and may be learned so that it may infer a region of interest corresponding to the particular environmental information and/or user input information. According to one or more embodiments, the processor may input the image and the environmental information into the second learning model TM2 learned as described above, and set the region of interest RF on the input image DWI on the basis of the inferred result. Furthermore, the processor may further input the user input information into the second learning model TM2 learned as described above, and further set the region of interest RF on the input image DWI on the basis of the inferred result.

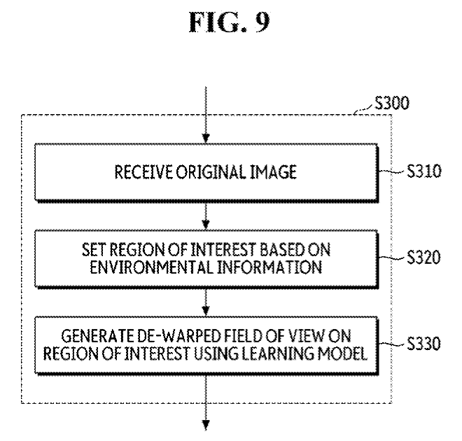

FIG. 9 is a flowchart for explaining a method for image de-warping according to one or more embodiments. Referring to FIG. 9, a method (S300) for image de-warping may include a step (S310) in which the processor receives an original image. Specifically, for example, the processor (e.g., 110 of FIG. 3 and/or 500 of FIG. 4) may receive an original image captured using a camera module (e.g., 300 of FIG. 3 and/or 700 of FIG. 4) having a first field of view.

According to one or more embodiments, the method (S300) for image de-warping may include a step (S320) in which the processor sets a region of interest (ROI) having a second field of view on the basis of environmental information. Field of view of the ROI and field of view of the original image may be different from each other. Specifically, for example, the processor (e.g., 110 of FIG. 3 and/or 500 of FIG. 4) may set a region of interest on the basis of environmental information. The environmental information may be information including a current driving state or the like of a vehicle equipped with an electronic device according to one or more embodiments. The environmental information may include, for example, speed information of a vehicle, steering angle information of the vehicle, and friction force information of the vehicle (or tires mounted on the vehicle) with the ground (e.g., the type of tires mounted on the vehicle, the degree of wear of the tires, the duration of use of the tires, etc.).

According to one or more embodiments, the method for image de-warping (S300) may include a step (S330) in which the processor generates a de-warped field of view on the region of interest, using a learning model. Specifically, for example, the processor (e.g., 110 of FIG. 3 and/or 500 of FIG. 4) may generate a de-warped field of view on the region of interest, using a learning model (e.g., an artificial intelligence model stored in the memory 120 of FIG. 3). A detailed method for image de-warping on the region of interest will be described below.

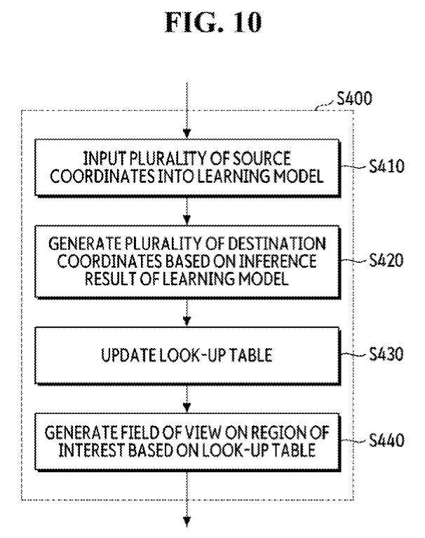

FIG. 10 is a flowchart for explaining a method for generating the de-warped field of view on the region of interest according to one or more embodiments. A method (S400) for generating the de-warped field of view on the region of interest will be described in detail with reference to FIG. 10. The method (S400) for generating the de-warped field of view on the region of interest may be an example of operation (S330) of FIG. 9, but operation (S330) is not limited to being performed in the manner described below.

According to one or more embodiments, the method (S400) for generating the de-warped field of view on the region of interest may include a step (S410) in which the processor inputs a plurality of source coordinates into a learning model. Specifically, for example, the processor (e.g., 110 of FIG. 3 and/or 500 of FIG. 4) may input a plurality of source coordinates on a look-up table corresponding to an original image into the learning model (e.g., an artificial intelligence model stored in the memory 120 of FIG. 3).

According to one or more embodiments, the method (S400) for generating the de-warped field of view on the region of interest may include a step (S420) in which the processor generates a plurality of destination coordinates on the basis of an inference result of the learning model. Specifically, for example, the processor (e.g., 110 of FIG. 3 and/or 500 of FIG. 4) may generate a plurality of destination coordinates on the look-up table on the basis of an inference result of the learning model (e.g., an artificial intelligence model stored in the memory 120 of FIG. 3). The learning model may be learned on the basis of a plurality of look-up tables. The learning model may be learned so that it may infer a plurality of destination coordinates for a region of interest when a plurality of source coordinates corresponding to the region of interest are input. The learning model may be further learned on the basis of a plurality of types of environmental information E_INFO and/or a plurality of types of user input information U_INFO. The plurality of types of environmental information E_INFO may include, for example, speed information of a vehicle, steering angle information of the vehicle, and/or friction force information of the vehicle with the ground. The plurality of types of user input information U_INFO may include, for example, user voice information and/or text information. The learning model may be learned so that it may infer the plurality of destination coordinates for a region of interest, when the plurality of source coordinates and environmental information corresponding to the region of interest are input, or when the plurality of source coordinates and user input information corresponding to the region of interest are input, or when the plurality of source coordinates, environmental information, and user input information corresponding to the region of interest are input.

According to one or more embodiments, the method (S400) for generating the de-warped field of view on the region of interest may include a step (S430) in which the processor generates the look-up table on the basis of the plurality of source coordinates and the plurality of destination coordinates. Specifically, for example, the processor (e.g., 110 of FIG. 3 and/or 500 of FIG. 4) may replace the destination coordinates on the look-up table that are already stored with the generated plurality of destination coordinates. If there is no already stored look-up table, the processor may generate a look-up table that includes the plurality of source coordinates and the plurality of destination coordinates corresponding to each source coordinate.

According to one or more embodiments, the method (S400) for generating a de-warped field of view on the region of interest may include a step (S440) in which the processor generates a field of view on the region of interest on the basis of the look-up table. Specifically, for example, the processor (e.g., 110 of FIG. 3 and/or 500 of FIG. 4) may perform the de-warping using the look-up table including a plurality of source coordinates and a plurality of destination coordinates corresponding to each source coordinate to generate a de-warped field of view on the region of interest.

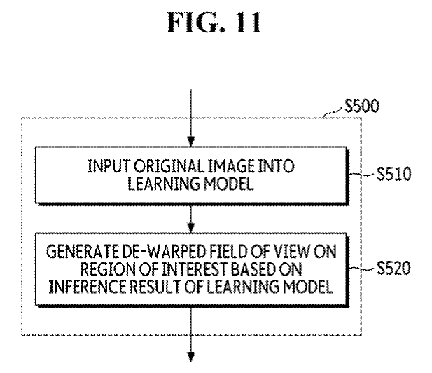

FIG. 11 is a flowchart for explaining a method for generating a de-warped field of view on the region of interest according to one or more embodiments. A method (S500) for generating the de-warped field of view on the region of interest will be described in detail with reference to FIG. 11. The method (S500) for generating the de-warped field of view on the region of interest may be an example of operation (S330) of FIG. 9, but is not limited to being performed in the manner described below.

According to one or more embodiments, the method (S500) for generating the de-warped field of view on the region of interest may include a step (S510) in which the processor inputs an original image into a learning model. Specifically, for example, the processor (e.g., 110 of FIG. 3 and/or 500 of FIG. 4) may input the original image into the learning model (e.g., an artificial intelligence model stored in the memory 120 of FIG. 3) having a first field of view.

According to one or more embodiments, the method (S500) for generating a de-warped field of view on the region of interest may include a step (S520) in which the processor generates a de-warped image having a second field of view on the region of interest on the basis of an inference result of the learning model. Field of view of the ROI and field of view of the original image may be different from each other. Specifically, for example, the processor (e.g., 110 of FIG. 3 and/or 500 of FIG. 4) may generate a de-warped image having the second field of view on the region of interest on the basis of the inference result of the learning model (e.g., the artificial intelligence model stored in the memory 120 of FIG. 3).

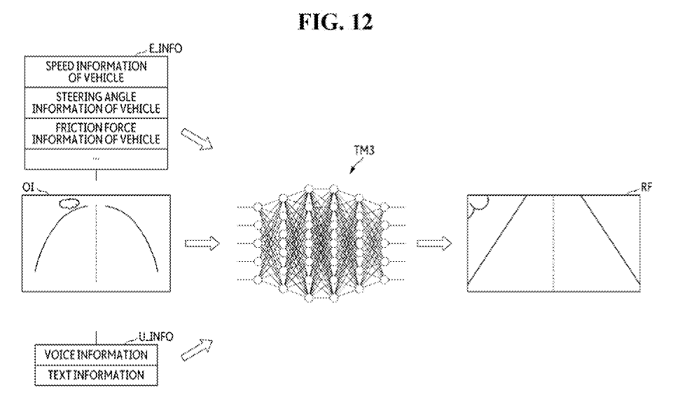

FIG. 12 is a diagram for explaining a method for generating a de-warped field of view on the region of interest according to one or more embodiments. Referring to FIG. 12, a third learning model TM3 may be used to generate a de-warped field of view on the region of interest. The third learning model TM3 may be learned on the basis of a plurality of original images and a plurality of de-warped images. For example, the third learning model TM3 may be learned to infer an image in which the distortion on a region of interest is corrected in a particular image when the particular image is input. In other words, the processor may simultaneously set a region of interest in a particular image using the third learning model TM3 and perform de-warping on the region of interest.

According to one or more embodiments, the third learning model TM3 may be learned further on the basis of a plurality of types of environmental information E_INFO and/or a plurality of types of user input information U_INFO. The plurality of types of environmental information E_INFO may include, for example, speed information of a vehicle, steering angle information of the vehicle, and/or friction force information of the vehicle with the ground, and the like. The plurality of types of user input information U_INFO may include, for example, user voice information and/or text information, and the like. For example, the third learning model TM3 may be learned so that it may infer an image in which distortion on a region of interest in a particular image is corrected, when a particular image and environmental information are input, or when a particular image and user input information are input, or when a particular image, environmental information, and user input information are input.

According to one or more embodiments, the processor may acquire one or more fields of view on one or more regions of interest even with a single camera module by executing the above-mentioned method. Furthermore, the processor may dynamically set the region of interest on the basis of the environmental information and/or user input information. That is, unlike FIG. 2, the region of interest is not fixed, but may be flexibly set depending on the environmental information and/or the user input information.

The original image acquired by a high-resolution camera module (as an example, a 4K image) may also have a relatively large size of the look-up table for de-warping, and may occupy a considerable space in the memory. According to one or more embodiments, the processor may dynamically generate a look-up table or dynamically perform de-warping only for the region of interest by executing the above-mentioned method, thereby improving the memory utilization and the data processing speed.

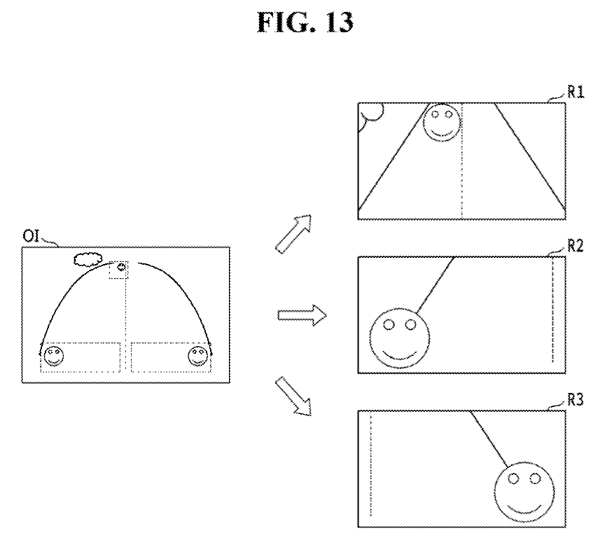

FIG. 13 is a diagram for explaining a method for image de-warping according to one or more embodiments. Referring to FIG. 13, there may be a plurality of regions of interest for the original image. As an example, to prevent a rear-end collision with a cut-in vehicle in a high-speed driving situation, the algorithm of the advanced driver assistance system and/or the autonomous driving system needs to acquire not only a long-distance field of view but also a side field of view.

According to one or more embodiments, a learning model (e.g., the first learning model TM1 of FIG. 6) may be learned so that it may infer a plurality of regions of interest corresponding to particular environmental information and/or user input information when the particular environmental information and/or user input information is input.

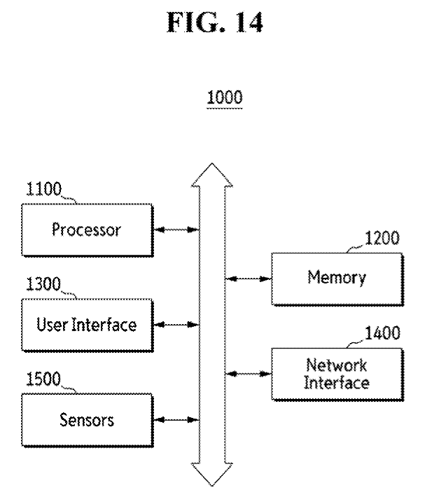

FIG. 14 is a block diagram for explaining a system according to one or more embodiments.

Referring to FIG. 14, a system 1000 may include a processor 1100, a memory 1200, a user interface 1300, a network interface 1400, and sensors 1500. The processor 1100, the memory 1200, the user interface 1300, the network interface 1400, and the sensors 1500 may be connected to each other through a bus.

The sensors 1500 may include, for example, an image sensor (camera module), a vision sensor, an acceleration sensor, a gyro sensor, a global positioning system (GPS) sensor, a radar, a lidar, and the like. The sensors 1500 may acquire (capture) an image related to the traveling situation of the vehicle. The sensors 1500 may sense information such as, for example, the GPS coordinates, position, attitude, speed, acceleration, traveling direction, steering angle, and the like of the vehicle. According to one or more embodiments, the sensors 1500 may include the above-mentioned camera module (e.g., 300 of FIG. 3). The sensors 1500 may provide, for example, at least some of the environmental information E_INFO and the user input information U_INFO of FIG. 6 to the processor 1100.

The network interface 1400 may perform wireless and/or wired communication with other electronic devices. The network interface 1400 may perform communication with other electronic devices, for example, via a third device (e.g., a repeater, a hub, an access point, a server or a gateway). The wireless communication may include a cellular communication that uses, for example, at least one of an LTE, an LTE Advance (LTE-A), a Code Division Plurality of Access (CDMA), a Wideband CDMA (WCDMA), a Universal Mobile Telecommunications System (UMTS), a Wireless Broadband (WiBro) or Global System for Mobile Communications (GSM). Further, the wireless communication may include, for example, at least one of a wireless fidelity (WiFi), a Bluetooth, a Bluetooth Low Power (BLE), a ZigBee, a near field communication (NFC), a magnetic secure transmission, a radio frequency (RF), or a body area network (BoA). The wired communication may include, for example, at least one of a universal serial bus (USB), a high definition multimedia interface (HDMI), a recommended standard 232 (RS-232), a power line communication, or a plain old telephone service (POTS). The network over which the wireless or wired communication is performed may include at least one of a telecommunications network, for example, a computer network (e.g., a LAN or WAN), an Internet, or a telephone network. According to one or more embodiments, the network interface 1400 may provide, for example, at least some of the environmental information E_INFO and user input information U_INFO of FIG. 6 to the processor 1100.

According to one or more embodiments, the system 1000 may be the electronic device above described through FIGS. 1-13 (e.g., the electronic device 1a of FIG. 3 or the electronic device 1b of FIG. 4). The processor 1100 may execute at least a part of the method for image de-warping described above through FIGS. 1-13 or an algorithm corresponding to at least a part of the method. The processor 1100 may include the processors described above (e.g., the first processor 110 and the second processor 200 of FIG. 3). The processor 1100 may include a processing device implemented in hardware including a processing circuit. For example, the processing device implemented in hardware may include, but is not limited to, a central processing unit (CPU), an arithmetic logic unit (ALU), a digital signal processor, a microcomputer, a field programmable gate array (FPGA), a system-on-system (SoC) logic, a programmable logic unit, a microprocessor, an application-specific integrated circuit (ASIC), and the like.

The processor 1100 may further include an accelerator, which is a dedicated circuit for high-speed data computation such as artificial intelligence (AI) data computation. The processor 1100 may further include, for example, a graphics processing unit (GPU), a neural processing unit (NPU), and a data processing unit (DPU), and the accelerator may be implemented as a separate chip physically independent of the processing device, but is not limited thereto.

The program to be executed by the processor 1100 may be stored in the memory 1200. When the program stored in the memory 1200 is executed by the processor 1100, the program may cause the processor 1100 to execute at least a part of the method for image de-warping described above through FIGS. 1-13. Furthermore, the memory 1200 may store various types of data and information generated in the process of the processor 1100 executing the method. The memory 1200 may include a volatile memory such as a static random access memory (SRAM) and/or a dynamic random access memory (DRAM), or a non-volatile memory such as a flash memory, a phase-change RAM (PRAM), a resistive RAM (RRAM), and a magnetic RAM (MRAM). The memory 1200 may also include a storage device such as a hard disk to store various types of data.

The user interface 1300 may receive various types of data that are input from a user of the system 1000, and may include a touch pad, a keypad, a keyboard, a mouse, and/or a microphone. According to one or more embodiments, the user interface 1300 may provide, for example, at least some of the environmental information E_INFO and the user input information U_INFO of FIG. 6 to the processor 1100.

According to one or more embodiments, a non-transitory computer-readable recording medium with a computer program stored therein is provided, and when the computer program is executed, the method for image de-warping as described above in FIGS. 1-13 may be implemented. For example, the non-transitory computer-readable recording medium may store one or more programs capable of implementing a method that includes at least a step of receiving an original image captured using a camera module, a step of setting a region of interest in the original image on the basis of environmental information, and a step of generating a de-warped field of view for the region of interest using a first learning model.

The computer-readable recording medium may be, for example, but is not limited to, an electrical, magnetic, optical, electromagnetic, infrared, semiconductor system, semiconductor device, or any combination thereof. More specific examples of the computer-readable recording medium may include an electrical connection using one or more electric wires, a portable computer disk, a hard disk, a random access memory (RAM), a read-only memory (ROM), an erasable programmable read-only memory (EPROM or flash), an optical fiber, a portable compact disk read-only memory (CD-ROM), an optical storage device, a magnetic storage device, or suitable combinations of the above matters. In one or more embodiments, the computer-readable recording medium may be any type of medium that includes or stores a computer program that may be used by a command execution system, device or device or together with them. The computer program included in the computer-readable recording medium may be transmitted using any suitable medium, including but not limited to wired, fiber optic cable, radio frequency (RF), or the like, or any suitable combination thereof. The computer-readable recording medium may be included in any device, or may be present independently without being incorporated into the device. Furthermore, according to one or more embodiments, a computer program product may also be provided, and the commands of the computer program product may be executed by a processor of a computer device to perform the above-mentioned method for image de-warping.

One or more embodiments may provide an electronic device, wherein the instructions, when executed by the at least one processor, further cause the at least one processor to: input the plurality of first source coordinates, the environmental information, and user input information into the learning model, and generate, by using the learning model based on the plurality of first source coordinates, the environmental information and the user input information, the plurality of first destination coordinates.

One or more embodiments may provide an electronic device, wherein the user input information comprises at least one: of user voice information or text information.

One or more embodiments may provide an electronic device, wherein the environmental information comprises at least one of: speed information of a vehicle, steering angle information of the vehicle, or friction force information of the vehicle with a ground.

One or more embodiments may provide an electronic device, wherein the instructions, when executed by the at least one processor, further cause the at least one processor to: update the lookup table in response to at least one of a change in position of the camera device, a change in orientation of the camera device, a change in focus of the camera device, and a change in one or more parameters of the camera device.

One or more embodiments may provide an electronic device, wherein the instructions, when executed by the at least one processor, further cause the at least one processor to: receive, from the camera device, a second original image having a third FOV, obtain a plurality of second source coordinates constituting the second original image, input the plurality of second source coordinates and the environmental information to the learning model, generate, by using the learning model based on the plurality of second source coordinates and the environmental information, a plurality of second destination coordinates constituting a second ROI having a fourth FOV different from the third FOV, and update the lookup table such that the lookup table includes the plurality of second source coordinates and the plurality of second destination coordinates.

One or more embodiments may provide an electronic device, wherein the camera device is a single camera device.

One or more embodiments may provide a method, wherein the inputting the plurality of first source coordinates and the environmental information into the learning model comprises: inputting the plurality of first source coordinates, the environmental information, and user input information into the learning model, and wherein the generating, by the learning model based on the plurality of first source coordinates and the environmental information, the plurality of first destination coordinates comprises: generating, by using the learning model based on the plurality of first source coordinates, the environmental information and the user input information, the plurality of first destination coordinates.

One or more embodiments may provide a method, wherein the user input information comprises at least one of: user voice information or text information.

One or more embodiments may provide a method, wherein the environmental information comprises at least one of: speed information of a vehicle, steering angle information of the vehicle, or friction force information of the vehicle with a ground.

One or more embodiments may provide a method, the method further comprising: updating the lookup table in response to at least one of a change in position of the camera device, a change in orientation of the camera device, a change in focus of the camera device, and a change in one or more parameters of the camera device.

One or more embodiments may provide a method, wherein the updating the lookup table comprises: receiving, from the camera device, a second original image having a third FOV; obtaining a plurality of second source coordinates constituting the second original image; inputting the plurality of second source coordinates and the environmental information to the learning model; generating, by using the learning model based on the plurality of second source coordinates and the environmental information, a plurality of second destination coordinates constituting a second ROI having a fourth FOV different from the third FOV; and updating the lookup table such that the lookup table includes the plurality of second source coordinates and the plurality of second destination coordinates.

Although one or more embodiments of the present disclosure have been described above with reference to the accompanying diagrams, the present disclosure may not be limited to one or more embodiments and may be implemented in various different forms. Those of ordinary skill in the technical field to which the present disclosure belongs will be able to appreciate that the present disclosure may be implemented in other specific forms without changing the technical idea or essential features of the present disclosure. Therefore, it should be understood that one or more embodiments as described above are not restrictive but illustrative in all respects.

What is claimed is:

1. A method for image de-warping performed by at least one processor, the method comprising:
receiving, from a camera device, a first original image having a first field of view (FOV);
obtaining a plurality of first source coordinates constituting the first original image;
inputting the plurality of first source coordinates and environmental information to a learning model;
generating, by using the learning model based on the plurality of first source coordinates and the environmental information, a plurality of first destination coordinates constituting a first region of interest (ROI) having a second FOV different from the first FOV;
generating a lookup table including the plurality of first source coordinates and the plurality of first destination coordinates; and
performing de-warping for a plurality of original images received from the camera device based on the lookup table.

2. The method for image de-warping of claim 1, wherein the inputting the plurality of first source coordinates and the environmental information into the learning model comprises:
inputting the plurality of first source coordinates, the environmental information, and user input information into the learning model, and
wherein the generating, by the learning model based on the plurality of first source coordinates and the environmental information, the plurality of first destination coordinates comprises:
generating, by using the learning model based on the plurality of first source coordinates, the environmental information and the user input information, the plurality of first destination coordinates.

3. The method for image de-warping of claim 2, wherein the user input information comprises at least one of: user voice information or text information.

4. The method for image de-warping of claim 1, wherein the environmental information comprises at least one of: speed information of a vehicle, steering angle information of the vehicle, or friction force information of the vehicle with a ground.

5. The method for image de-warping of claim 1, the method further comprising:
updating the lookup table in response to at least one of: a change in position of the camera device, a change in orientation of the camera device, a change in focus of the camera device, or a change in one or more parameters of the camera device.

6. The method for image de-warping of claim 5, wherein the updating the lookup table comprises:
receiving, from the camera device, a second original image having a third FOV;
obtaining a plurality of second source coordinates constituting the second original image;
inputting the plurality of second source coordinates and the environmental information to the learning model;
generating, by using the learning model based on the plurality of second source coordinates and the environmental information, a plurality of second destination coordinates constituting a second ROI having a fourth FOV different from the third FOV; and
updating the lookup table such that the lookup table includes the plurality of second source coordinates and the plurality of second destination coordinates.

7. The method for image de-warping of claim 1, wherein the camera device is a single camera device.

8. An electronic device comprising:
a camera device;
at least one processor; and
memory storing instructions,
wherein the instructions, when executed by the at least one processor, cause the at least one processor to:
receive, from the camera device, a first original image having a first field of view (FOV),
obtain a plurality of first source coordinates constituting the first original image,
input the plurality of first source coordinates and environmental information to a learning model,
generate, by using the learning model based on the plurality of first source coordinates and the environmental information, a plurality of first destination coordinates constituting a first region of interest (ROI) having a second FOV different from the first FOV,
generate a lookup table including the plurality of first source coordinates and the plurality of first destination coordinates, and
perform de-warping for a plurality of original images received from the camera device based on the lookup table.

9. The electronic device of claim 8, wherein the instructions, when executed by the at least one processor, further cause the at least one processor to:
input the plurality of first source coordinates, the environmental information, and user input information into the learning model, and
generate, by using the learning model based on the plurality of first source coordinates, the environmental information and the user input information, the plurality of first destination coordinates.

10. The electronic device of claim 8, wherein the user input information comprises at least one: of user voice information or text information.

11. The electronic device of claim 8, wherein the environmental information comprises at least one of: speed information of a vehicle, steering angle information of the vehicle, or friction force information of the vehicle with a ground.

12. The electronic device of claim 8, wherein the instructions, when executed by the at least one processor, further cause the at least one processor to:
update the lookup table in response to at least one of a change in position of the camera device, a change in orientation of the camera device, a change in focus of the camera device, and a change in one or more parameters of the camera device.

13. The electronic device of claim 8, wherein the instructions, when executed by the at least one processor, further cause the at least one processor to:
receive, from the camera device, a second original image having a third FOV,
obtain a plurality of second source coordinates constituting the second original image,
input the plurality of second source coordinates and the environmental information to the learning model,
generate, by using the learning model based on the plurality of second source coordinates and the environmental information, a plurality of second destination coordinates constituting a second ROI having a fourth FOV different from the third FOV, and
update the lookup table such that the lookup table includes the plurality of second source coordinates and the plurality of second destination coordinates.

14. The electronic device of claim 8, wherein the camera device is a single camera device.

15. A non-transitory computer-readable medium storing instructions which, when executed by at least one processor, cause the at least one processor to execute a method for image de-warping, the method comprising:
receiving, from a camera device, a first original image having a first field of view (FOV);
obtaining a plurality of first source coordinates constituting the first original image;
inputting the plurality of first source coordinates and environmental information to a learning model;
generating, by using the learning model based on the plurality of first source coordinates and the environmental information, a plurality of first destination coordinates constituting a first region of interest (ROI) having a second FOV different from the first FOV;
generating a lookup table including the plurality of first source coordinates and the plurality of first destination coordinates; and
performing de-warping for a plurality of original images received from the camera device based on the lookup table.

16. The non-transitory computer-readable medium of claim 15, wherein the inputting the plurality of first source coordinates and the environmental information into the learning model comprises:
inputting the plurality of first source coordinates, the environmental information, and user input information into the learning model, and
wherein the generating, by the learning model based on the plurality of first source coordinates and the environmental information, the plurality of first destination coordinates comprises:
generating, by using the learning model based on the plurality of first source coordinates, the environmental information and the user input information, the plurality of first destination coordinates.

17. The non-transitory computer-readable medium of claim 16, wherein the user input information comprises at least one of: user voice information or text information.

18. The non-transitory computer-readable medium of claim 15, wherein the environmental information comprises at least one of: speed information of a vehicle, steering angle information of the vehicle, or friction force information of the vehicle with a ground.

19. The non-transitory computer-readable medium of claim 15, the method further comprising:
updating the lookup table in response to at least one of a change in position of the camera device, a change in orientation of the camera device, a change in focus of the camera device, and a change in one or more parameters of the camera device.

20. The non-transitory computer-readable medium of claim 19, wherein the updating the lookup table comprises:
receiving, from the camera device, a second original image having a third FOV;
obtaining a plurality of second source coordinates constituting the second original image;
inputting the plurality of second source coordinates and the environmental information to the learning model;
generating, by using the learning model based on the plurality of second source coordinates and the environmental information, a plurality of second destination coordinates constituting a second ROI having a fourth FOV different from the third FOV; and
updating the lookup table such that the lookup table includes the plurality of second source coordinates and the plurality of second destination coordinates.
